(19) United States
(12) Patent Application Publication
(10) Pub. No.: US 2026/0133813 A1
(43) Pub. Date: May 14, 2026

(54) COMPUTER SYSTEM AND METHOD FOR MOBILE DEVICE DIGITAL FORENSIC INVESTIGATIONS

(71) Applicant: Magnet Forensics Inc., Waterloo (CA)

(72) Inventor: Christopher Vance, Huntington, WV (US)

(21) Appl. No.: 19/385,489

(22) Filed: Nov. 11, 2025

Related U.S. Application Data
(60) Provisional application No. 63/720,466, filed on Nov. 14, 2024.

(51) Int. Cl. G06F 9/451; G06F 3/0482; G06F 11/30

(52) U.S. Cl. CPC G06F 9/451; G06F 3/0482; G06F 11/3051

(57) ABSTRACT

A system and method for providing a visual representation of content contained on a mobile device is provided herein. the system comprises a data collection module for detecting an operating system of a mobile device and collecting device data from the mobile device, an application filtering module for searching the device data for applications and determining an application type for each of the applications; a data filtering module for filtering the device data based on the applications to determine device data associated with each of the applications, and a graphical user interface (GUI) generation module for generating a first GUI which mimics an operating system of the mobile device and includes graphical icons for the applications, and generating a second GUI upon selection of a graphical icon of one of the plurality of applications, wherein the second GUI displays the device data associated with the selected application.

### TECHNICAL FIELD

The following relates generally to digital forensics, and more particularly to systems and methods for processing and visualizing digital forensic data retrieved or extracted from mobile devices.

### BACKGROUND

Currently, during most digital forensic investigations of mobile devices (e.g., smartphones or tablets), an investigator views data taken from the device on an interface with a layout which is not similar to how the data would be presented or accessed on a mobile device, for example a list of files/data. Therefore, searching for specific data and analyzing how data is interconnected is not intuitive. A one-to-one emulation of a device is time consuming and difficult to accomplish.

With the growing amount of information available on mobile devices, a streamlined workflow and quick access to information is needed for both seasoned examiners and untrained consumers of investigative reports such as prosecutors or detectives.

Accordingly, there is a need for an improved system and method for digital forensic investigation system and methods that overcome at least some of the disadvantages of existing systems and methods to allow for non-technical and technical stakeholders to accurately and quickly review mobile device information.

### SUMMARY

There is provided a system for providing an intuitive visual representation of files and data contained on a mobile device to an investigator. The system includes a data collection module configured to detect an operating system of a target mobile device, and to collect target device data from the target mobile device through a communication interface; an application filtering module configured to parse the target device data for a plurality of applications based on operating system data associated with the operating system of the target mobile device, and to determine an application type for each of the plurality of applications based on stored application type data; a data filtering module configured to filter the target device data based on the plurality of applications and the application type data to determine target device data associated with each of the plurality of applications; and a graphical user interface (GUI) generation module. The GUI module generates a first GUI based on the operating system data, the plurality of applications, and the application types, wherein the first GUI mimics an operating system of the target mobile device and includes graphical icons for the plurality of application; and generates a second GUI upon selection of a graphical icon of one of the plurality of applications, wherein the second GUI displays the target device data associated with the selected application.

The application types may include standard applications which are on mobile devices of a given operating system and have preset saved filters, supported applications which are downloaded onto the target mobile device by a user of the target mobile device and have preset saved filters, and unsupported applications which are downloaded onto the target mobile device by the user but does not have a preset saved filter.

The preset saved filters may represent a pre-established set of data which is known to be associated with a specific supported application.

The system may include a forensic data processing application configured to generate the preset saved filters by determining application-specific artifacts from previously acquired mobile device data to be used as the pre-established set of data associated with standard application and supported applications.

The target device data may be filtered by the data filtering module for an unsupported application by searching for the bundle ID associated with a specific unsupported application.

The GUI generating module may include a mobile explorer interface submodule which generates the first GUI.

The GUI generating module may include an evidence user interface submodule which generates the second GUI.

The GUI generating module may generate the first GUI based on a prepopulated system artifact layout associated with the operating system of the target mobile device.

The data collection module may collect a full copy of the target device data of the target mobile device.

The data collection module may collect a subset of the target device data of the target mobile device.

There is also provided a method for providing an intuitive visual representation of files and data contained on a mobile device to an investigator. The method includes detecting an operating system of a target mobile device; collecting target device data from the target mobile device through a communication interface; parsing the target device data for a plurality of applications based on operating system data associated with the operating system of the target mobile device; determining an application type for each of the plurality of applications based on stored application type data; filtering the target device data based on the plurality of applications and the application type data to determine target device data associated with each of the plurality of applications; generating a first GUI based on the operating system data, the plurality of applications, and the application types, wherein the first GUI mimics an operating system of the target mobile device and includes graphical icons for the plurality of application; and generating a second GUI upon selection of a graphical icon of one of the plurality of applications. The second GUI displays the target device data associated with the selected application.

The application types may include standard applications which are on mobile devices of a given operating system, supported applications which are downloaded onto the target mobile device by a user of the target mobile device and have preset saved filters, and unsupported applications which are downloaded onto the target mobile device by the user but does not have a preset saved filter.

The preset saved filters may represent a pre-established set of data which is known to be associated with a specific supported application.

The method may further include a forensic data processing application configured to generate the preset saved filters by determining application-specific artifacts from previously acquired mobile device data to be used as the pre-established set of data associated with standard application and supported applications.

The target device data may be filtered by the data filtering module for an unsupported application by searching for the bundle ID associated with a specific unsupported application.

The GUI generating module may include a mobile explorer interface submodule which generates the first GUI.

The GUI generating module may include an evidence user interface submodule which generates the second GUI.

The GUI generating module may generate the first GUI based on a prepopulated system artifact layout associated with the operating system of the target mobile device.

The data collection module may collect a full copy of the target device data of the target mobile device.

The data collection module may collect a subset of the target device data of the target mobile device.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a computing system, according to an embodiment;

FIG. 2 is a block diagram of a mobile explorer computing system, according to an embodiment;

FIG. 3 is a schematic diagram of a target device interface of a mobile explorer graphical user interface, according to an embodiment;

FIG. 4 is a block diagram of a mobile explorer interface, according to an embodiment;

FIG. 5 is a schematic diagram of a mobile explorer interface, according to an embodiment;

FIG. 6A is an image of a results interface of a mobile explorer system, according to an embodiment;

FIG. 6B is an image of a results interface of a mobile explorer system, according to an embodiment;

FIG. 6C is an image of a results interface of a mobile explorer system, according to an embodiment;

FIG. 6D is an image of a results interface of a mobile explorer system, according to an embodiment;

FIG. 7 is a flow diagram of a method of acquiring and parsing data from a mobile device for a mobile explorer system, according to an embodiment;

FIG. 8 is a flow diagram of a method of generating a target device interface of mobile explorer graphical user interface, according to an embodiment;

FIG. 9 is a flow diagram of a method of viewing results in a mobile explorer system for a selected application, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of embodiments of the present invention.

Further, although process steps, method steps, algorithms or the like may be described (in the disclosure and/or in the claims) in a sequential order, such processes, methods, and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates to digital forensics, and more particularly to systems and methods for processing and visualizing digital forensic data retrieved or extracted from the computer-readable storage media of mobile devices (or other similar devices).

Described herein are mobile explorer systems and methods which provide a visual representation of the files and data contained on a mobile device which mimics the user interface and operating system of the mobile device to allow an investigator to explore the mobile device intuitively. The mobile explorer system provides a shortcut between recognizing an application exists on a mobile device and analyzing the data associated with the application. Instead of filtering and searching through all of the target device data for data associated with the application, the investigator simply clicks on an application icon in a graphical user interface similar to the operating system of the device to apply at least one preset saved application filter to the target device data.

The preset saved filters allow for fine filtering of data to only data associated with a specific application. For example, while in previous investigation methods an investigator could filter to view only images, with the mobile explorer system the investigator can filter to view only images associated with a photo gallery (e.g., not icons, webpages, etc.)

Each preset saved filter represents a curated, pre-established set of data which is known to be associated with a specific application. To create a preset saved filter, a multitude of data points related to a specific application is be determined to ensure that the filter is accurate and provides artifacts which are specific to the application and not generalized artifacts which may be associated with more than one application. The preset saved filters may be stored in a temporary directory.

Given enough time, any application could be a supported application with a preset saved filter. However, the number of applications available for mobile devices is large and therefore it is generally more cost-effective and time-saving to target the most commonly used applications to be supported with icons and preset saved filters.

The mobile explorer system accesses a target mobile device to acquire target device data, in the form of files, artifacts, metadata, etc., and generates a mobile explorer interface for the investigator which incorporates key system level artifacts of the target mobile device, such as pre-determined icons which a user would expect to see based on the particular operating system of the target mobile device. The mobile explorer system may also include icons for target mobile device specific applications detected on the mobile device. Data associated with the applications can be accessed by clicking on the icons. In this way, an investigator can access all information associated with a particular application quickly. For example, instead of searching through a list of photos from an Android phone to find photos from a specific application, e.g., Facebook Messenger, the investigator can instead click on the Facebook Messenger icon on an interface which looks like an android operating system and access all of the files associated with Facebook Messenger.

The interface generated by the mobile explorer system is not identical to the interface of the target mobile device. Instead, the mobile applications which are supported by the mobile explorer system and are likely to be most relevant to a digital forensic investigation are displayed most prominently, e.g., at the top of the interface. Standard applications which are on all mobile devices which has the target mobile device operating system (e.g., iOS, Android, etc.), such as phone application, photo application, mapping application, etc., are displayed first, e.g., at the top of the interface. Applications which are supported by the mobile explorer system but are not standard for every mobile device of the operating system are displayed second, e.g., below the standard applications, for example, Instagram, TikTok, SnapChat, etc. Applications which are not standard and are not supported by the mobile explorer system are displayed third, e.g. below the other applications or on a different “screen” or “page” of the interface.

When an investigator selects an application on the interface which is supported by the mobile explorer system by clicking on the application icon, data associated with the application is shown on an evidence interface as a visualization which at least partially mimics how the data would appear on the target mobile device. That is, pictures may be shown in a gallery or chat messages may be shown as in the messaging application. When the investigator selects an application which is not supported by the mobile explorer system by clicking on the application icon, data associated with the application is shown in the evidence interface as a list of data and does not mimic the appearance of the unsupported application.

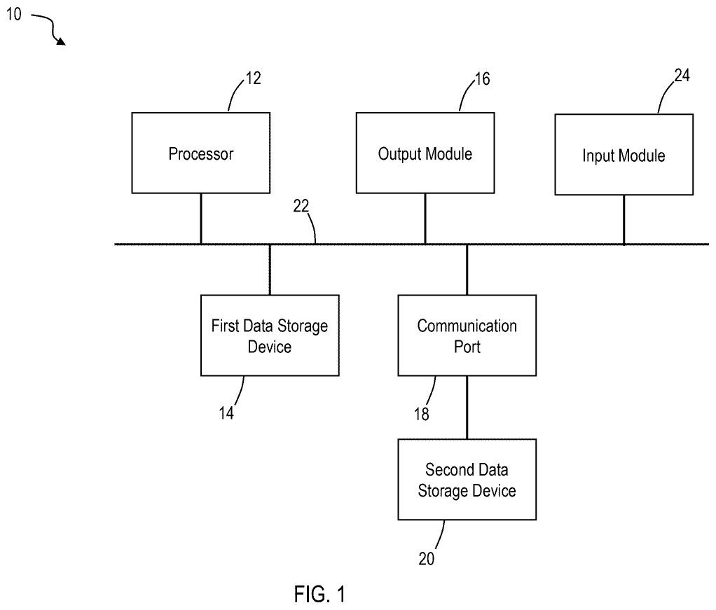

Referring now to FIG. 1, shown therein is a computer system 10 for providing a mobile explorer system which allows an investigator to perform a digital forensic investigation through an interface which mimics a mobile target device, according to an embodiment.

The system 10 includes a processor 12, a first data storage device 14, an output module 16, a communication port 18, a second data storage device 20 coupled to the communication port 20 and an input module 24. In this embodiment, the various components 12, 14, 16, 18, and 24 of the system 10 are operatively coupled using a system bus 22.

The system 10 may use various electronic devices such as personal computers, networked computers, portable computers, portable electronic devices, personal digital assistants, laptops, desktops, mobile phones, smart phones, tablets, and so on.

The first data storage device 14 includes any mobile device, such as a mobile phone, smartphone, tablet computer, etc., which has a standard operating system, e.g., iOS or Android operating system, with mobile device applications. In some examples, the first data storage device 14 may include a hard disk drive, a solid-state drive, or any other form of suitable data storage device and/or memory that may be used in various electronic devices. The data storage device 14 may have various data stored thereon. Generally, the data stored on the data storage device 14 includes data that may be of forensic value to a digital forensic investigation and from which forensic artifacts can be recovered or extracted and then processed or analyzed (e.g., ranked or scored according to relevance) and displayed in a graphical user interface.

In the embodiment as shown, another data storage device in addition to the first data storage device 14, namely the second data storage device 20, is provided. The second data storage device 20 may be used to store computer-executable instructions that can be executed by the processor 12 to configure the processor 12 to locate and acquire target mobile device data and display the acquired data in a mobile explorer interface based on data stored in the data storage device 14 or of data acquired from the first data storage device 14 and stored in the second data storage device 20.

It should be noted that it is not necessary to provide a second data storage device, and in other embodiments, the instructions may be stored in the first data storage device 14 or any other data storage device.

In some cases, the first data storage device 14 may be a data storage device external to the system 10 or processor 12. For example, the first data storage device 14 may be a data storage component of an external computing device (e.g., a data server) that stores forensic evidence for subsequent processing and display. In such cases, the processor 12 may be configured to execute computer-executable instructions (stored in second data storage device 20) to acquire digital forensic evidence of the first data storage device 14 and store the digital forensic evidence in the second data storage device 20.

The processor 12 is configured to provide a user interface to the output module 16. The output module 16, for example, may be a suitable display device, and/or output device coupled to the processor 12. The display device may include any type of device for presenting visual information. For example, the display device may be a computer monitor, a flat-screen display, a projector, or a display panel. The output device may include any type of device for presenting a hard copy of information, such as a printer for example. The output device may also include other types of output devices such as speakers, for example. The user interface allows the processor 12 to solicit input from a user regarding various types of operations to be performed by the processor 12. The user interface also allows for the display of various output data and selections, such as case type selections and other data inputs and timeline or map visualizations of surfaced data artifacts, generated by the processor 12.

The input module 24 may include any device for entering information into system 10. For example, input module 24 may be a keyboard, keypad, cursor-control device, touchscreen, camera, or microphone. It will be appreciated that in certain embodiments the input module 24 and the output module 16 are the same device. As an example, the input module 24 and the output module 16 may be a single touchscreen, or a smart speaker.

The system 10 may be a purpose-built machine designed specifically for surfacing and displaying first generation material from a target device. In some cases, system 10 may include multiple of any one or more of processors, applications, software modules, second storage devices, network connections, input devices, output devices, and display devices.

The system 10 may include a server computer, desktop computer, notebook computer, tablet, PDA, smartphone, or another computing device. The system 10 may include a connection with a network such as a wired or wireless connection to the Internet. In some cases, the network may include other types of computer or telecommunication networks. The system 10 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage devices may include a hard disk drive, floppy disk drive, CD drive, DVD drive, Blu-ray drive, or other types of non-volatile data storage. Processor 12 may execute applications, computer readable instructions or programs. The applications, computer readable instructions or programs may be stored in memory or in secondary storage or may be received from the Internet or other network.

Although system 10 is described with various components, one skilled in the art will appreciate that the system 10 may in some cases contain fewer, additional, or different components. In addition, although aspects of an implementation of the system 10 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the system 10 and/or processor 12 to perform a particular method.

In the description that follows, devices such as system 10 are described performing certain acts. It will be appreciated that any one or more of these devices may perform an act automatically or in response to an interaction by a user of that device. That is, the user of the device may manipulate one or more input devices (e.g., a touchscreen, a mouse, or a button) causing the device to perform the described act. In many cases, this aspect may not be described below, but it will be understood.

As an example, a user using the system 10 may manipulate one or more input devices (not shown; e.g., a mouse and a keyboard) to interact with a user interface displayed on a display of the system 10. In some cases, the system 10 may generate and/or receive a user interface from the network (e.g., in the form of a webpage). Alternatively, or in addition, a user interface may be stored locally at a device (e.g., a cache of a webpage or a mobile application).

In response to receiving information, the system 10 may store the information in storage database. The storage may correspond with secondary storage of the system 10. The storage database may be any suitable storage device such as a hard disk drive, a solid state drive, a memory card, or a disk (e.g., CD, DVD, or Blu-ray etc.). Also, the storage database may be locally connected with the system 10. In some cases, the storage database may be located remotely from system 10 and accessible to system 10 across a network for example. In some cases, the storage database may comprise one or more storage devices located at a networked cloud storage provider.

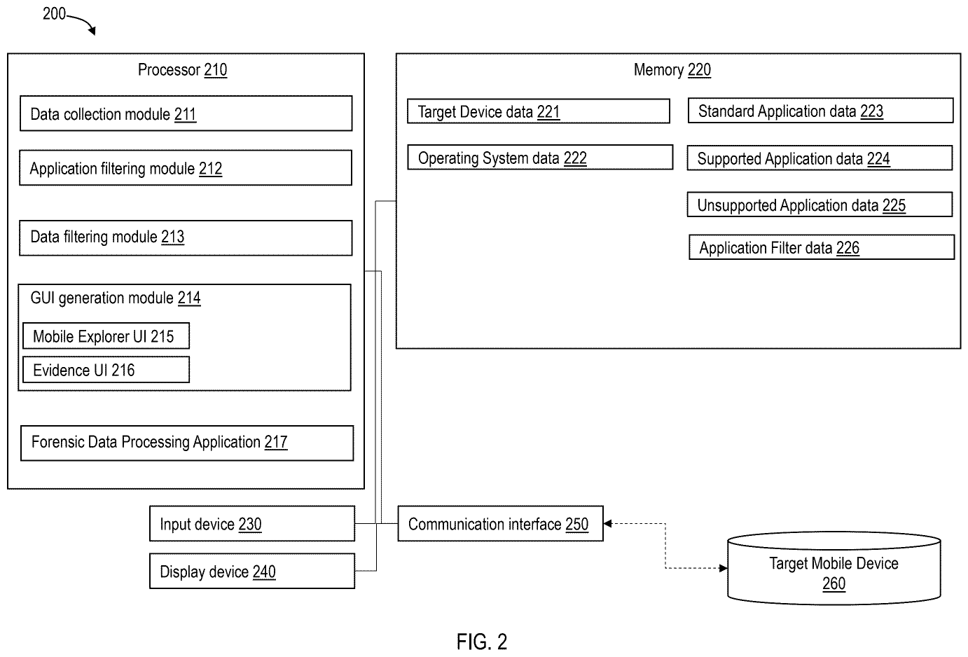

Referring now to FIG. 2, shown therein is a computer system 200 for processing and visualizing target mobile device data, according to an embodiment.

The system 200 may be implemented by the system 10 of FIG. 1.

Components of the computer system 200 may be implemented at one or more devices, such as a server platform and a user device, for example, the second data storage device of FIG. 1.

The system 200 includes a processor 210 and a memory 220, wherein the processor 210 and the memory 220 are communicatively connected. The processor 210 is configured to execute various software modules and components. In some embodiments, modules or components executed by the processor 210 may include software components that communicate with each other in order to provide various features and functionalities of the system 200.

The system 200 includes a communication interface 250 for transmitting and receiving data to and from other computing devices. The communication interface 250 may include a network interface device for transmitting and receiving data via a network connection (e.g., local area network, wide area network, etc.).

The system 200 includes a display device 240 for displaying data generated by the system 200.

The system 200 includes an input device 230 for receiving input data from a user interacting with the system 200. For example, a user may use input device 230 to interact with the system 200 through a graphical user interface generated by the processor 220 and displayed via the display device 240.

Processor 210 includes a data collection module 211, an application filtering module 212, a data filtering module 213, and a graphical user interface (GUI) generation module 214. The GUI module 214 may include a mobile explorer user interface submodule 215, an evidence user interface submodule 216, and a forensic data processing application 217.

Memory 220 includes target device data 221, operating system data 222, standard application data 223, supported application data 224, unsupported application data 225, and application filter data 226.

The processor 210 is communicatively connected to a target mobile device 260 through communication interface 250.

The data collection module 211 acquires target device data 221 from a target mobile device 260 through communication interface 250. The target device data 221 is stored in memory 220.

Operating system data 222 includes information related to the operating system of possible target mobile devices. That is, the operating system data 222 may includes data related to iOS™, Android operating system, or other operating systems. The operating system data 222 is used by the GUI generation module 213 to generate the GUI that is appropriate for the target mobile device 260. The operating system data 222 includes a prepopulated system artifact layout for a given operating system.

The application filtering module 212 determines an application type for each of the applications found on the target mobile device 260. Standard applications are applications which are provided with the device. Supported applications are user-installed applications which are not standard for the operating system but are supported by the mobile explorer system. Unsupported applications are user-installed applications which are not standard for the operating system (i.e., not loaded on a new mobile device) and are not supported by the mobile explorer system. The standard applications, supported applications, and unsupported applications are determined using the standard application data 223, supported application data 224, and unsupported application data 225. The specific standard application data 223, supported application data 224, and unsupported application data 225 may be chosen based on the operating system of the target mobile device.

The data filtering module 213 accesses the target device data 221 and filters the target device data 221 based on the applications which were found on the target mobile device 260 using application filter data 226.

Application filter data 226 includes preset saved filters which are generated by forensic data processing application 217. Forensic data processing application 217 extracts and/or refines forensic artifacts from an acquired forensic data collection (e.g., data acquired from other investigations or by other means). The forensic data processing application 217 determines which types of artifacts are associated with specific applications. Artifacts associated with a specific application, or “application-specific” artifacts, are then used to generate a preset saved filter which can be used to find application-specific data on a target mobile device. Standard applications and supported applications has preset saved filters.

The GUI generation module 214 generates a graphical user interface for an investigator of the target mobile device 260 to interact with the target device data 221 to find evidence or other data of interest.

The mobile explorer user interface submodule 215 generates a target device interface which mimics an interface for the target mobile device's operating system. That is, the target device interface looks like a screen of a mobile device of the target mobile device's type. For example, if the target mobile device 260 is an iPhone the target device interface will look like an iPhone screen.

However, on the target device interface the application icons may not be at the same locations as on the target mobile device interface. That is, the target device interface is not a direct one-for-one copy of the target mobile device interface. The target device interface is designed to allow easy navigation by the investigator, not to represent the exact set-up and interface of the target mobile device 260.

The evidence interface submodule 216 generates an evidence interface for viewing data acquired from the target mobile device 260. The investigator interacts with the target device interface generated by the mobile explorer user interface submodule 215 to choose an application and the evidence interface submodule 216 generates an evidence interface for the investigator to view the target device data associated with the selected application.

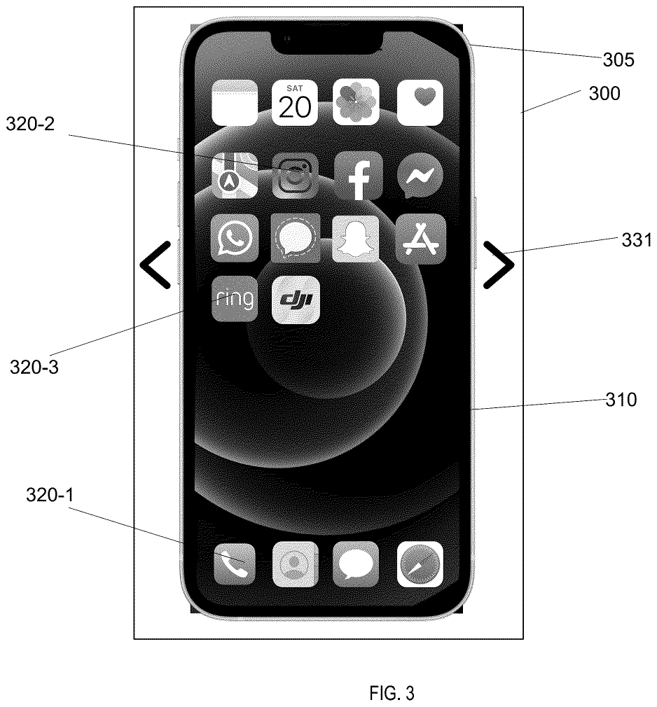

FIG. 3 is a schematic diagram of a target device interface 300 of a mobile explorer GUI, according to an embodiment.

The target device interface 300 is based on an iPhone™ target mobile device. The target device interface 300 has been generated using target device data acquired from the target mobile device.

The target device interface 300 includes a device outline 305 in the shape of an iPhone™. A background 310 of the phone may be generic or may be the same as the background of the actual target mobile device as found in the target device data acquired from the target mobile device.

Application icons, collectively 320, are positioned in locations identical to the possible locations on an iPhone™.

Icons 320-1 for standard applications (i.e., applications which are on every iPhone™, for example, a phone application, a navigation application, a text message application, a contacts application etc.) are displayed at the bottom of the interface and at the top of the interface. Icons 320-2 for supported applications (i.e., third-party applications which the target mobile device user has installed onto their device and which are supported by the mobile explorer system) are displayed at the top of the interface 300 below and standard application icons 320-1 which are at the top of the interface 300. Icons 320-3 for unsupported applications (i.e., third-party applications which the target mobile device user has installed and which are not supported by the mobile explorer system) are displayed below the supported icons. Some icons are unlabelled to avoid clutter.

In other embodiments, standard, supported, and unsupported application icons may be displayed in other configurations.

If there are more application icons 320 than there is space for within a single device outline 305, then application icons may be placed on a second screen (or third, fourth, etc., as required) which can be accessed by selecting the arrow 331 on the right of the device outline 305. Previous screens can be accessed by selecting the arrow 332 on the left side of the device outline 305.

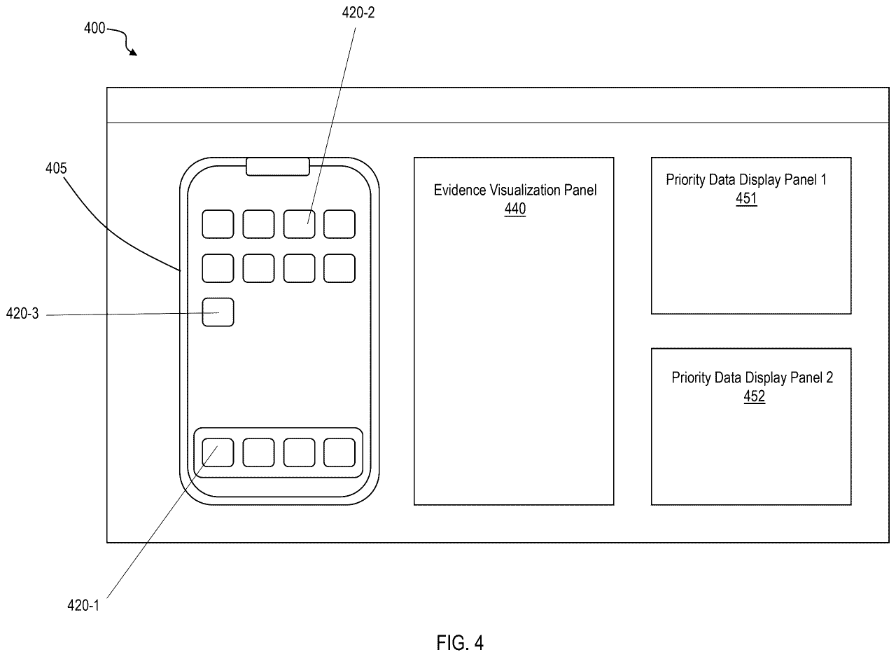

FIG. 4 is a block diagram of a mobile explorer graphical user interface 400, according to an embodiment.

The user interface 400 includes a target device interface 405, similar to target device interface 300 of FIG. 3.

The target device interface 405 includes application icons as derived from acquired target device data. Only some icons are labelled to avoid clutter. The application icons include those for standard application 420-1, supported applications, 420-2, and unsupported application 420-3 as described above.

The mobile explorer GUI 400 includes an evidence visualization panel 440 which displays target device data. The target device data displayed in the evidence visualization panel 440 may represent possible evidence or may represent data which is relevant to the investigation but would not be considered evidence. Before an application icon has been selected the evidence visualization panel 440 may display general device information. After an application icon has been selected the evidence visualization panel 400 may display target device data associated with the selected application.

The mobile explorer GUI 400 includes two additional priority data display panels 451 and 452 which may display information which has been determined to be a possible priority due to predicted relevance to the investigation.

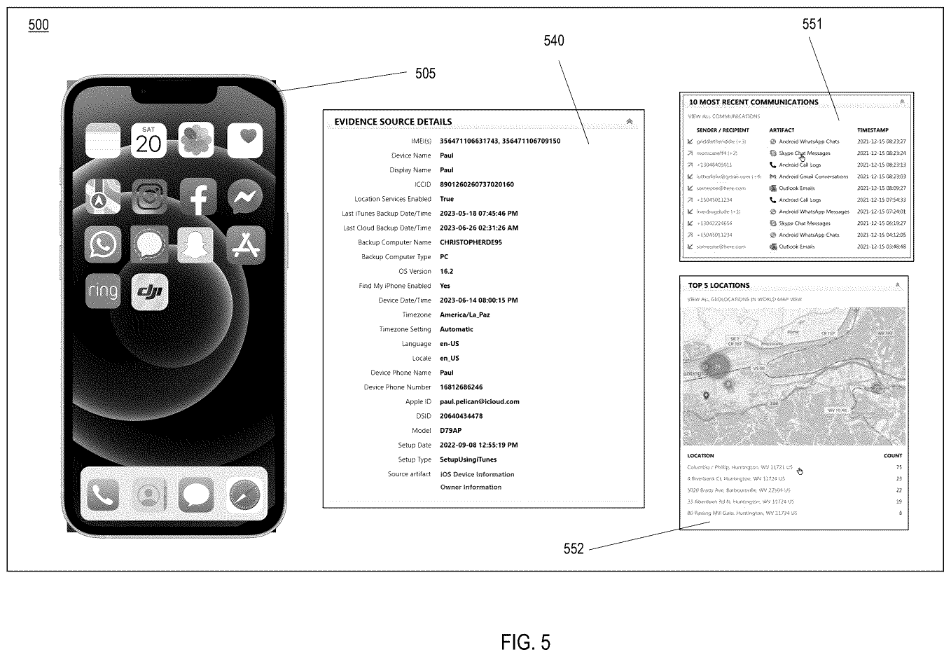

FIG. 5 is a schematic diagram of a mobile explorer graphical user interface 500, according to an embodiment. The mobile explorer GUI 500 may be similar to mobile explorer GUI 400 of FIG. 4.

The mobile explorer GUI 500 includes a target device interface 505, an evidence visualization panel 540, and two priority data display panels 551 and 552.

The target device interface 505 is the same as shown above for the target device interface 300.

The evidence visualization panel 540 shows evidence source details which include identification details for the target mobile device which is the evidence source. For example, a device name, display name, last backup dates, operating system version, timezone, language, phone number, Apple ID, etc. are shown.

The priority data display panels 551 and 552 show specific details about how, where, and when the target mobile device has been used.

Priority data display panel 551 shows the ten most recent communications either sent or received by the target mobile device, the artifact type (e.g., type of message sent/received), and the time of the communication.

Priority data display panel 552 shows the top five locations where the target mobile device has been, with a map of the locations, and a list of the locations with a count of the number of times the target mobile device has been at each location.

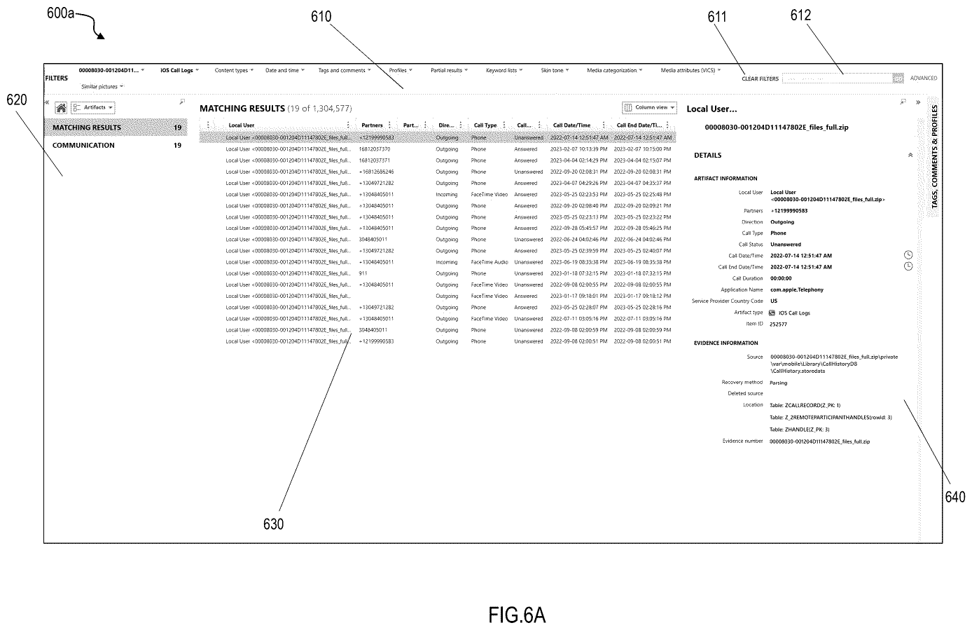

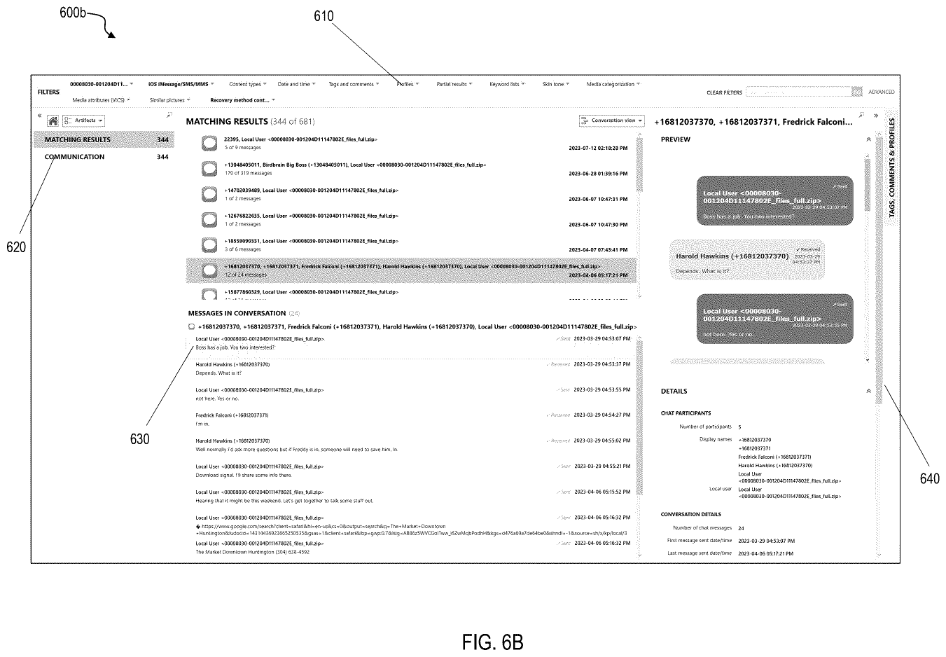

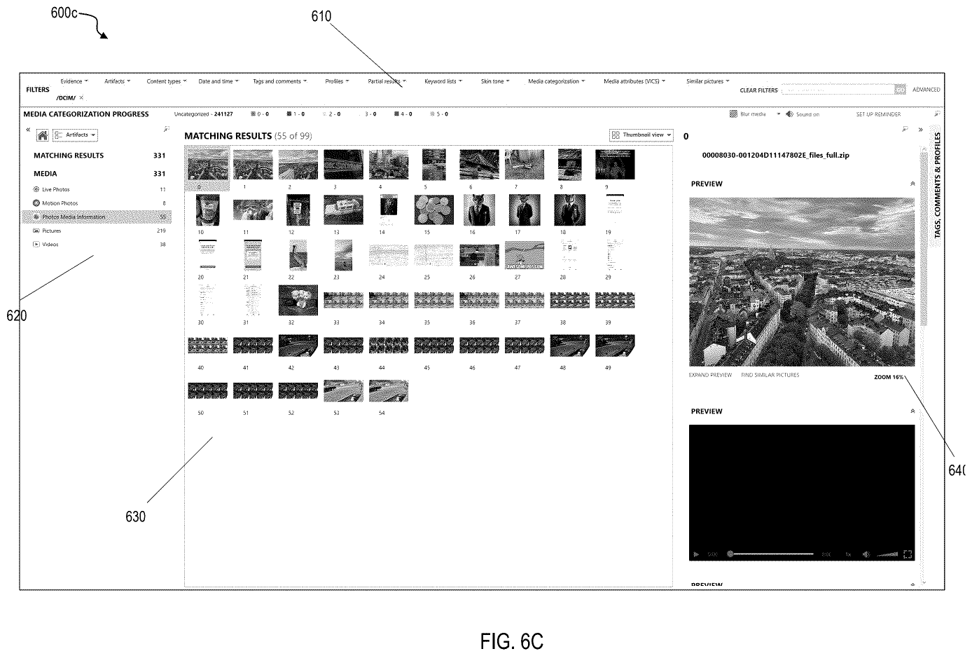

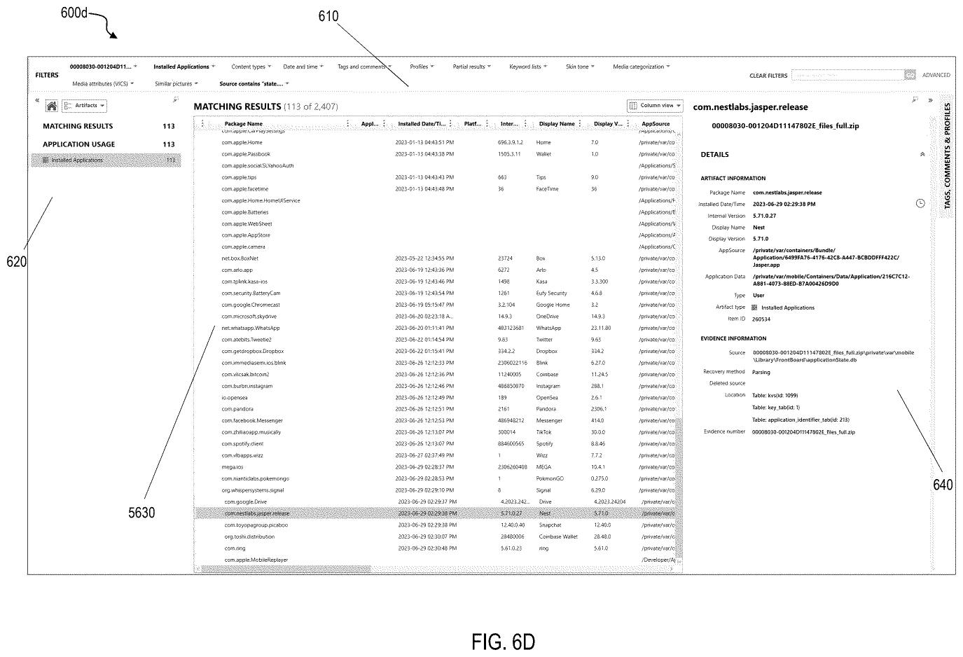

FIGS. 6A-D are images of a results interface displaying results for various applications. For all of the results interfaces, the matching results displayed are acquired by filtering the target device data according to pre-set filters associated with applications. Standard and supported applications will have associated pre-set filters with pre-established sets of data, while unsupported applications will not have pre-set filters with pre-established sets of data.

For an unsupported application, an investigator may manually apply filters or a bundle ID filter may be automatically applied when the unsupported application is selected. The bundle ID of the selected unsupported application may be used to search for artifacts within the target mobile device, by applying a filter which searches for the phrase that is the bundle ID.

While using manual filters or bundle ID filters for unsupported applications may not provide the same interface or experience for the investigator as using a preset saved filter for a support application, the manual and bundle ID filters still provide a faster and more efficient process for finding and reviewing artifacts associated with the application than previous methods. The process is improved to require fewer clicks (i.e., less computer processing and fewer processing cycles) and to be shortened to a scale of seconds versus previous methods which might take minutes or hours.

FIG. 6A is an image of a call application results interface 600a of a mobile explorer system, according to an embodiment. In FIG. 6A, an investigator has selected a call application icon, for example the phone icon at the bottom of the interface of FIGS. 3 and 5, and results associated with the phone application are displayed as a list on a results interface 600a of the mobile explorer system. The call application is a standard application.

The results interface 600a includes a filter bar 610 at the top of the interface which the investigator can use to apply filters to the results which are associated with the call application. In FIG. 6A, the iOS call logs filter has been automatically applied as that is a preset saved filter which is associated with the iPhone call application.

The filters shown are standard and may or may not be relevant to the selected application. For example, filtering by date and time would be relevant for voice calls, while filtering by skin tone would not be relevant for voice calls but might be relevant for video calls.

There is a clear filter button 611 on the filter bar 610 to enable an investigator to remove all filters from the results.

There is a search bar 612 on the filter bar 610 to enable an investigator to search through the results using keywords.

The results interface 600a includes a results sidebar 620 on the left which enables the investigator to navigate between all matching results and matching results of a certain type, for example communication results, media results, etc. FIG. 6A only has communication results but for some applications there may be more than one type of result and/or subtypes of results which can be navigated at the sidebar 620.

The results interface 600a includes a matching results panel 630 in the center which displays a list or other configuration of matching results. In FIG. 6A, the matching results are shown as a list of calls and video calls performed by the call application and matching any filters which have been chosen.

The results interface 600a includes a current result panel 640 on the right which displays information about the result which is currently selected from the matching results.

At the far right of the results interface 600a is a tags, comments, and profiles tab which the investigator can open to add tags and/or comments, view tags and/or comments, and add or remove results from case profiles.

The specific layout of the results interface 600a as well as the individual functionalities (e.g., specific filters, search bar, tags, comments, etc.) may differ for other embodiments of the mobile explorer system.

FIG. 6B is an image of a messaging application results interface 600b of a mobile explorer system, according to an embodiment. In FIG. 6B, an investigator has selected a messaging application icon, for example the speech bubble icon at the bottom of the interface of FIGS. 3 and 5, and results associated with the messaging application are displayed as a list on a results interface 600a of the mobile explorer system.

As with the call application, the messaging application is a standard application. However, other messaging applications, e.g., WhatsApp™, Instagram™, etc., which are supported by the mobile explorer system may have similar results interfaces. Messaging applications which are not supported by the mobile explorer system would not have a similar results interface, but the investigator may manually apply filters (no preset saved filters) to find data associated with the unsupported applications.

The results interface 600b includes the same filter bar 610 as in FIG. 6A. The “iOS iMessage/SMS/MMS” filter has been automatically applied as a preset saved filter by the mobile explorer system because the messaging application was selected.

FIG. 6B also includes the same sidebar 620 as FIG. 6A with navigation between the matching results and subtypes of matching results. As with FIG. 6A, FIG. 6B only has communication results.

The results interface 600b also includes the matching results panel 630 in the center which displays data related to conversations in a top panel and a bottom panel. In FIG. 6A, the matching results are shown as a list of conversation in the top panel and a list of messages within a selected conversation in the bottom panel.

The current result panel 640 on the right which displays information about the currently selected conversation including specific messages in a top preview panel and details about the conversation (i.e., chat participants, number of messages, date time of first and last messages) in a bottom detail panel.

FIG. 6C is an image of a camera roll application results interface of a mobile explorer system, according to an embodiment. In FIG. 6C, an investigator has selected a photos icon, for example the flower icon at the top of the interface of FIGS. 3 and 5, and results associated with the photos application are displayed as a list of thumbnails on a results interface 600a of the mobile explorer system. The photos application is a standard application.

The results interface 600c includes the same filter bar 610 as in FIG. 6C. The “DCIM” filter has been automatically selected as a preset saved filter by the mobile explorer system because the photos application was selected.

FIG. 6B also includes the same sidebar 620 as FIG. 6A with navigation between the matching results and subtypes of matching results. The subtypes in FIG. 6C include “media”, with further media subtypes being “live photos”, “motion photos”, “photos media information”, “pictures”, and “videos”.

The results interface 600c includes the matching results panel 630 in the center which displays data related to the camera roll application as a list of thumbnails. The matching results panel 630 in FIG. 6C is showing only photos media information representing 55 images associated with the camera roll application.

The current result panel 640 on the right displays a larger preview of the currently selected image. The current result panel includes an “expand preview” button to enable the investigator to view a larger preview image and a “find similar pictures” button to enable the investigator to navigate to a list of similar pictures to the currently selected image.

FIG. 6D is an image of a results interface of a mobile explorer system for unsupported application, according to an embodiment. In FIG. 6D, an investigator has selected an application icon of an unsupported application, for example the Ring™ application icon at the middle of the interface of FIGS. 3 and 5.

For an unsupported application, the preset saved filter of the mobile explorer system, which is selected is “installed applications”, as seen in the filter bar 610.

FIG. 6D includes the same sidebar 620 as FIG. 6A with navigation between the matching results and subtypes of matching results. FIG. 6D has “application usage” as a subtype, with “installed applications” as a further subtype.

The results interface 600d includes the matching results panel 630 in the center which displays a list of installed applications on the target mobile device.

The current result panel 640 on the right displays information regarding the currently selected installed application, including when the application was installed, the version type, an AppSource, an artifact type, information about how the evidence was acquired, etc. The information includes “Application Data” which may be a link which is clickable by the investigator to navigate to target data which is associated with the unsupported application(e.g., target data associated with a bundle ID of the unsupported application).

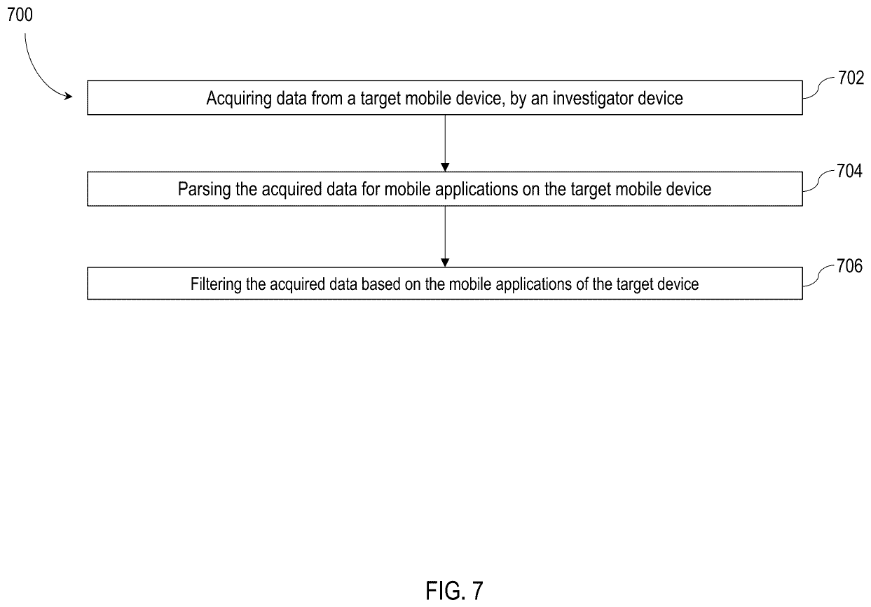

FIG. 7 is a flow diagram of a method 700 of acquiring and parsing data from a target mobile device for a mobile explorer system, according to an embodiment.

At 702, an investigator device acquires data from a target mobile device. As described above, the investigator device and the target mobile device are communicatively connected through a communication interface, either wired or wirelessly.

The investigator device may acquire a full copy of the target device data or may only acquire partial target device data, as is relevant to the particular investigation.

The investigator device may include a data collection module as described in FIG. 2.

At 704, the acquired target device data is parsed for applications. That is, the investigator device parses the target device data to find any applications present on the target mobile device including standard applications which come pre-installed on the device, and supported and unsupported applications which are third-party application installed by the user of the target mobile device. The investigator device may include an application filtering module as described in FIG. 2 to perform application parsing.

At 706, the acquired target device data is filtered based on the parsed applications from act 704. That is, the investigator device filters the target device data such that data associated with each of the parsed applications is found. For standard and supported applications the filters associated with each application are preset saved filters which are set before the investigation, and selecting an application within the mobile explorer GUI applies the preset saved filters to the target device data. The investigator device may include a data filtering module as described in FIG. 2 to perform data filtering.

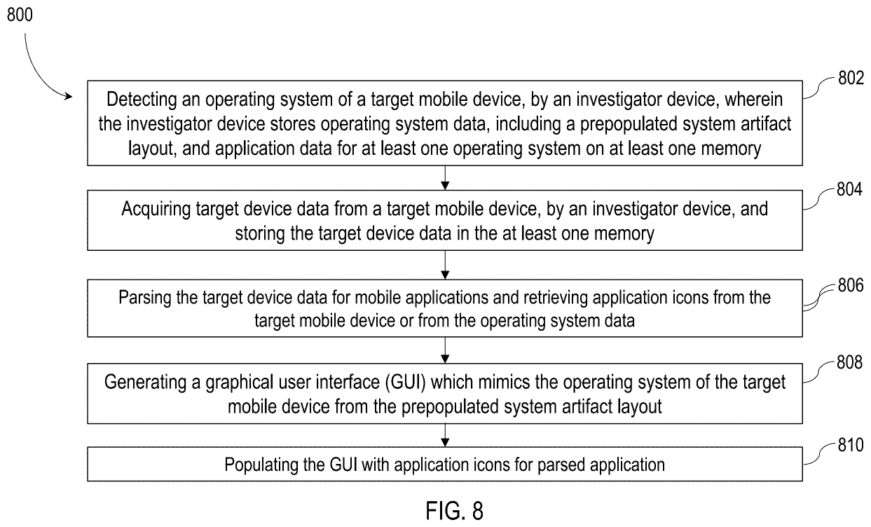

FIG. 8 is a flow diagram of a method 800 of generating a target device interface of a mobile explorer graphical user interface, according to an embodiment.

At 802, an investigator device detects an operating system of a target mobile device. The investigator device stores operating system data and application data for at least one operating system in at least one memory. The investigator device may use the operating system data to determine the operating system of the target mobile device or may determine the operating system of the target mobile device through other means.

The investigator device may store information for multiple different operating systems. The operating system data includes a prepopulated system artifact layout for each operating system. The prepopulated system artifact layout includes a layout which mimics the layout of a screen of a device running the given operating system. That is, the prepopulated system artifact layout for iOS™ is designed to have a generic layout of an iPhone™ of iPad™, while the prepopulated system artifact layout for an Android™ operating system is designed to have a generic layouts of an Android™ device. As Android™ phones are built by many different manufacturers, the detection of the operating system of an Android™ target mobile device may include detecting the manufacturer or specific model of mobile device and there may be manufacturer or model specific prepopulated system artifact layouts.

At 804, the investigator device acquired target device data from the target mobile device as described above at act 702 of method 700. The target device data is stored in the at least one memory of the investigator device.

At 806, the target device data is parsed for applications as described above at act 704 of method 700. Application icons for each parsed application are retrieved. The icons may be retrieved from the operating system data, from the target device data, or both. That is, the icons may be retrieved from whichever location is possible or more efficient. For example, standard and support application icons may be retrieved from the operating system data while unsupported application icons, which may not be present in the operating system data, may be retrieved from the target device data. Unsupported application icons which were not previously stored in the operating system data may be acquired from the target device data and stored in the operating system data for future investigations.

At 808, the investigator device generates a graphical user interface (GUI) which mimics the operating system of the target mobile device using the prepopulated system artifact layout. The target device data may include a wallpaper of the target mobile device and the GUI may include the background. Having the actual background of the target mobile device allows the investigator to distinguish between investigations.

At 810, the GUI is populated with the application icons associated with the parsed target mobile device applications. The resulting GUI, while not an identical version of the GUI of the target mobile device, displays an interface which is navigable in the same manner as a generic operating system of the target mobile device, with icons present in the same locations that icons could be present on an actual device screen (but not the same exact location for each application, except possibly by chance). This allows an investigator to navigate to applications as they would if they had a target mobile device in hand. Clicking on an application icon does not bring up an interface which mimics the actual application but, for standard and supported applications, does bring up an interface showing target device data associated with the selected application. Selection of a standard or supported application icon applies at least one preset saved filter to the target device data.

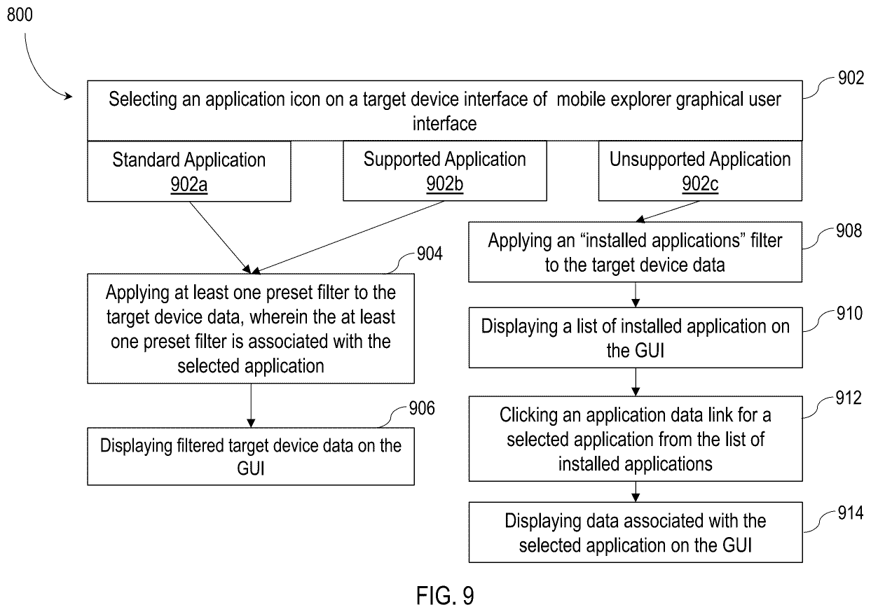

FIG. 9 is a flow diagram of a method 900 of viewing results in a mobile explorer system depending on the type of application selected, according to an embodiment.

At 902, an application icon is selected on a target device interface of a mobile explorer graphical user interface (GUI) as generated at steps 808 and 810 of method 800. The selected application may be a standard application 902a, a supported application 902b, or an unsupported application 902c.

At 904, a standard application 902 a or a supported application 902 b has been selected. Upon selection of the application by clicking on the application icon, at least one preset saved filter associated with the selected application is applied to the acquired target device data of the target mobile device.

At 906, filtered target device data, as filtered by the at least one preset saved filter, is displayed on the GUI.

At 908, an unsupported application 902 c has been selected, and a preset “installed applications” filter is applied to the target device data.

At 910, a list of installed third-party applications which are not supported applications is displayed on the GUI. Information for a currently selected unsupported application is also shown on the GUI.

At 912, an application data link displayed on the GUI for the currently selected unsupported application is clicked by the investigator.

At 914, target device data associated with the selected unsupported application is shown on the GUI.

The above processes of method 900 are described above for FIG. 6A-6D.

While the above description provides examples of one or more apparatus, methods, or systems, it will be appreciated that other apparatus, methods, or systems may be within the scope of the claims as interpreted by one of skill in the art.

1. A system for providing an intuitive visual representation of files and data contained on a mobile device to an investigator, comprising:
a data collection module configured to detect an operating system of a target mobile device, and to collect target device data from the target mobile device through a communication interface;
an application filtering module configured to parse the target device data for a plurality of applications based on operating system data associated with the operating system of the target mobile device, and to determine an application type for each of the plurality of applications based on stored application type data;
a data filtering module configured to filter the target device data based on the plurality of applications and the application type data to determine target device data associated with each of the plurality of applications; and
a graphical user interface (GUI) generation module configured to:
generate a first GUI based on the operating system data, the plurality of applications, and the application types, wherein the first GUI mimics an operating system of the target mobile device and includes graphical icons for the plurality of application; and
generate a second GUI upon selection of a graphical icon of one of the plurality of applications, wherein the second GUI displays the target device data associated with the selected application.

2. The system of claim 1, wherein the application types include standard applications which are on mobile devices of a given operating system and have preset saved filters, supported applications which are downloaded onto the target mobile device by a user of the target mobile device and have preset saved filters, and unsupported applications which are downloaded onto the target mobile device by the user but does not have a preset saved filter.

3. The system of claim 2, wherein the preset saved filters represent a pre-established set of data which is known to be associated with a specific supported application.

4. The system of claim 3, further comprising a forensic data processing application configured to generate the preset saved filters by determining application-specific artifacts from previously acquired mobile device data to be used as the pre-established set of data associated with standard application and supported applications.

5. The system of claim 2, wherein target device data is filtered by the data filtering module for an unsupported application by searching for the bundle ID associated with a specific unsupported application.

6. The system of claim 1, wherein the GUI generating module includes a mobile explorer interface submodule which generates the first GUI.

7. The system of claim 1, wherein the GUI generating module includes an evidence user interface submodule which generates the second GUI.

8. The system of claim 1, wherein GUI generating module generates the first GUI based on a prepopulated system artifact layout associated with the operating system of the target mobile device.

9. The system of claim 1, wherein the data collection module collects a full copy of the target device data of the target mobile device.

10. The system of claim 1, wherein the data collection module collects a subset of the target device data of the target mobile device.

11. A method for providing an intuitive visual representation of files and data contained on a mobile device to an investigator, comprising:
detecting an operating system of a target mobile device;
collecting target device data from the target mobile device through a communication interface;
parsing the target device data for a plurality of applications based on operating system data associated with the operating system of the target mobile device;
determining an application type for each of the plurality of applications based on stored application type data;
filtering the target device data based on the plurality of applications and the application type data to determine target device data associated with each of the plurality of applications;
generating a first GUI based on the operating system data, the plurality of applications, and the application types, wherein the first GUI mimics an operating system of the target mobile device and includes graphical icons for the plurality of application; and
generating a second GUI upon selection of a graphical icon of one of the plurality of applications, wherein the second GUI displays the target device data associated with the selected application.

12. The method of claim 11, wherein the application types include standard applications which are on mobile devices of a given operating system, supported applications which are downloaded onto the target mobile device by a user of the target mobile device and have preset saved filters, and unsupported applications which are downloaded onto the target mobile device by the user but does not have a preset saved filter.

13. The method of claim 12, wherein the preset saved filters represent a pre-established set of data which is known to be associated with a specific supported application.

14. The method of claim 13, further comprising a forensic data processing application configured to generate the preset saved filters by determining application-specific artifacts from previously acquired mobile device data to be used as the pre-established set of data associated with standard application and supported applications.

15. The method of claim 12, wherein target device data is filtered by the data filtering module for an unsupported application by searching for the bundle ID associated with a specific unsupported application.

16. The method of claim 11, wherein the GUI generating module includes a mobile explorer interface submodule which generates the first GUI.

17. The method of claim 11, wherein the GUI generating module includes an evidence user interface submodule which generates the second GUI.

18. The method of claim 11, wherein GUI generating module generates the first GUI based on a prepopulated system artifact layout associated with the operating system of the target mobile device.

19. The method of claim 11, wherein the data collection module collects a full copy of the target device data of the target mobile device.

20. The method of claim 11, wherein the data collection module collects a subset of the target device data of the target mobile device.
